(19) United States
(12) Patent Application Publication
(10) Pub. No.: US 2006/0022806 A1
(43) Pub. Date: Feb. 2, 2006

(54) Medicament container

(76) Inventor: David M. Auerbach, Calabasas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/910,129

(22) Filed: Aug. 2, 2004

(51) Int. Cl. G08B 1/00; G04B 47/00; G08B 3/00

(52) U.S. Cl. 340/309.16; 340/691.6; 368/10

(57) ABSTRACT

An apparatus and method for storing a medicament and alerting a patient when to take the medicament. The apparatus contains a processor, which is programmed to indicate when the patient is scheduled to take a medicament, and which medicament is to be taken. At the scheduled time, the patient is alerted and at least one characteristic (i.e. size, shape, color, etc.) of the medicament scheduled to be taken is described to the patient. The patient is also able to view previously scheduled medicaments as well as a schedule of medicaments to be taken in the future.

### BACKGROUND

1. Field

Medicament container.

2. Background Art

Prior art devices and methods have been developed which inform patients that it is time to take a medicament. For example, U.S. Pat. No. 6,507,275 recites a pill dispensing case including a reminder for assisting a patient to remember to take one or more pills at a preferred time.

An embodiment includes a microprocessor held in a case. The microprocessor includes a 24 hour clock and outputs information to both a warning indicator and a data display window at programmed times. The microprocessor is connected to a data link interface which is capable of receiving programming information. The case may include one or more pill compartments depending on whether there is more than one type of medicament. A warning signal transmission unit may also be provided separately from the case and may transmit a warning signal generated from the case to a mobile or stationary receiver via wireless or wired output.

### BRIEF DESCRIPTION OF THE DRAWINGS

Features, aspects, and advantages of the various embodiments will become more thoroughly apparent from the following detailed description, appended claims, and accompanying drawings in which:

FIG. 1 shows a top, side perspective view of one embodiment of a medicament container.

FIG. 2 shows a front, side perspective view of the medicament container of FIG. 1.

FIG. 3 shows the medicament container of FIG. 1 being carried on a person.

FIG. 4 shows a cross-sectional view of the medicament container of FIG. 1 including a schematic view of representative electronic components associated with the medicament container and shows the medicament container connected to an independent computing device.

FIG. 5 shows a representation of a series of displays of the medicament container of FIG. 1.

FIG. 6 shows an embodiment of a method instructing a patient to take medicaments.

### DETAILED DESCRIPTION

It is common for patients to take multiple medicaments for multiple ailments during the same period of time. Also, it is common for patients to forget to take a medicament at times instructed by a healthcare professional. In situations involving different medicaments, when patients do remember, patients often forget how each medicament looks individually. This is particularly true with prescription medicaments since most prescription medicaments rely on the package label to identify the medicament.

These problems are amplified when a patient is scheduled to take a medicament at a time when the patient is away from home and the patient's attention is directed toward something other than taking a medicament. Patients typically do not take an entire package (e.g., a pill bottle), which identifies the medicament, with them when going somewhere. Rather, patients tend to just carry (e.g., in a container) the minimum amount of medicament(s) necessary to be taken during their absence from home. Additionally, while away from home many patients become distracted and forget to take their medicament(s) at the scheduled time.

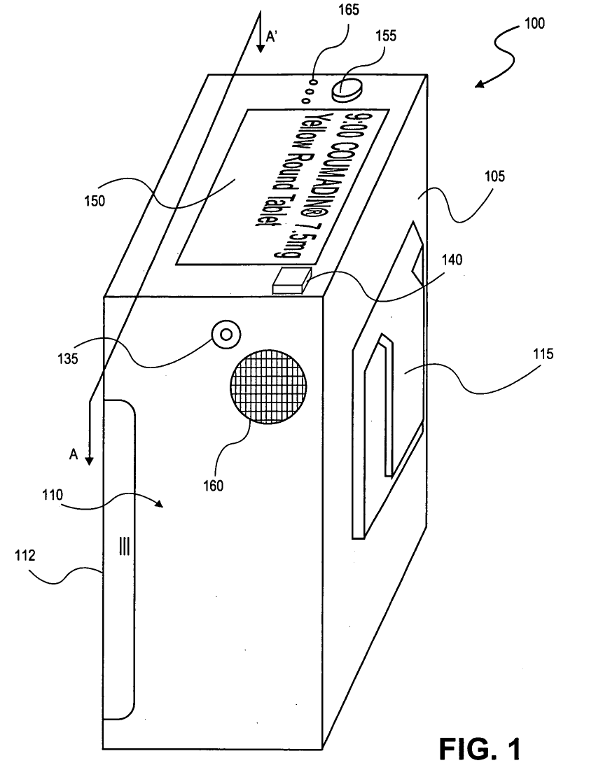

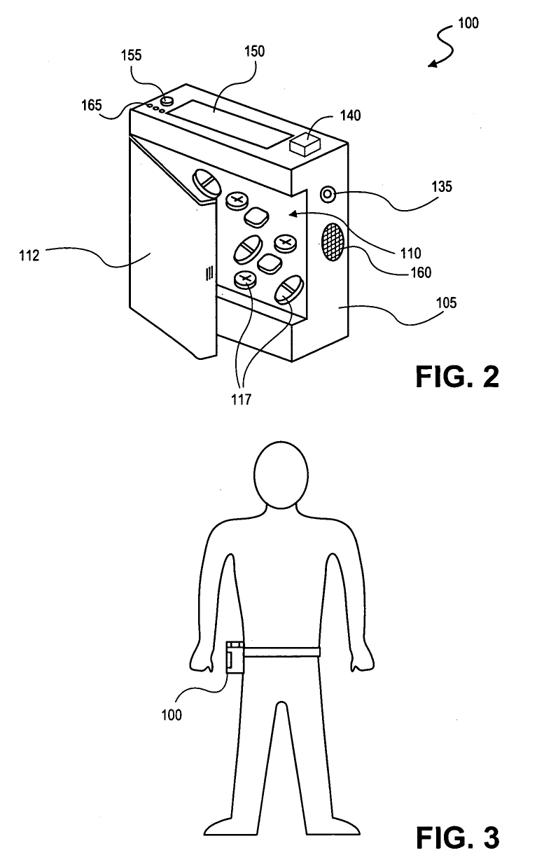

FIG. 1 and FIG. 2 show an embodiment of a medicament container. Representatively, medicament container 100 includes case 105, which includes enclosed compartment 110 of a size suitable to hold several medicaments. In one embodiment, compartment 110 is unrestricted in that it does not contain any sub-compartments (e.g., walls) for separating medicaments. Suitable medicaments include, but are not limited to tablets, capsules, gel capsules, liquids, powders, sprays, lotions, creams, ointments, etc. containing a therapeutic compound or portion thereof.

By “therapeutic compound” it is meant any substance used to treat (including prevent, diagnose, alleviate, or cure) a malady, affliction, nutritional deficiency, disease or injury in a patient. The term “therapeutic compound” is also meant to include substances that are a supplement for improving the nutritional, physical, or emotional well-being of a patient such as vitamins, minerals, or herbal based supplements. By “patient” it is meant a human and/or animal such as a mammal or reptile under the care of an administrator such as a physician or veterinarian.

Case 105 can be made of plastic, metal or any other durable, light-weight material suitable for use in holding medicaments and transportable by a patient. In one embodiment, case 105 is in the shape of a rectangular (including a square) box. In terms of plastic material, case 105 may be formed through molding techniques. Although shown as a rectangular box, it is contemplated that case 105 may have any shape suitable for use in holding medicaments and equipment suitable for alerting a patient it is time to take a medicament. For example, in another embodiment, case 105 may include a nylon or cloth body defining compartment 110 (e.g., of a size similar to a purse or “fanny pack” on a belt or to be worn around a patient's waist).

As shown in FIG. 1 and FIG. 2, case 105 includes a top portion, a bottom portion, a front portion, a back portion, and opposing side portions that define a depth of case 105. Representatively, case 105 has length and width dimensions of about three inches by about two to three inches, respectively, and a depth of about one to two inches. Other embodiments of case 105 may include larger and/or smaller dimensions. A depth dimension is selected, in one embodiment, to hold multiple (e.g., several) medicaments.

Case 105 includes, in this embodiment, compartment 110 accessible through partially or completely detachable door 112 on the front portion of case 105 (e.g., a partially detachable door may have one or more hinges that are connected to each of door 112 and case 105). FIG. 2 shows a front view of medicament container 100 with door 112 partially open to show compartment 110. As viewed, compartment 110 is a single, hollow area defined by case 105 suitable for holding multiple medicaments 117. In one embodiment, compartment 110 is configured to allow various medicaments 117 to be co-mingled within compartment 110 without the need for sorting. FIG. 2 shows various medicaments 117 randomly placed within compartment 110.

In the embodiment shown in FIG. 1 and FIG. 2, medicament container 100 is light weight and relatively small so that it is easy for a person to transport. FIG. 3 shows an embodiment of a medicament container attached to the belt of a person. In one embodiment, medicament container 100 includes clip 115 (see FIG. 1), such as a plastic body mounted at one end to a back portion of case 105 and extending longitudinally in a cantilever fashion, such that a patient may attach clip 115, for example, to a person's belt.

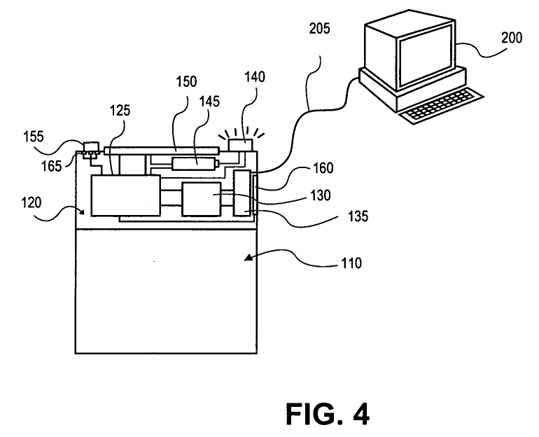

Referring again to FIG. 1 and FIG. 2, medicament container 100 also includes, in this embodiment, display 150 on a top portion of case 105. A top portion of case 105 also includes, in this embodiment, indicator 140, switch 155, and audio receiver 165. One side portion of case 105 includes, in this embodiment, interface 135 and audible output device 160. Details about display 150, indicator 140, switch 155, audio receiver 165, interface 135, and audible output device 160 are discussed with reference to FIG. 4.

FIG. 4 shows a cross-sectional side view of case 105 through line A-A′ of FIG. 1. Case 105 includes compartment 110 having dimensions suitable to hold multiple medicaments. In one embodiment, case 105 also includes interior space 120 containing processor 125, memory 130, and power source 145. Interior space 120 is shown separated from compartment 110 (e.g., by an internal wall).

Processor 125 in the embodiment shown in FIG. 4 is connected to memory 130 and power source 145. In one embodiment, processor 125 may be a microprocessor, including a dedicated uniquely designed architecture processor, or any other suitable microprocessor or microcomputer. Thus, processor 125 can be a processor sufficient to execute computer software embodied in a computer program product.

Referring to FIG. 4, processor 125 is connected (e.g., electrically connected) to memory 130. In one embodiment, memory 130 is of a size suitable to store medicament information data (e.g., name, dosage, descriptions, etc.) as well other data (e.g., time, date, patient instructions, etc.). In another embodiment, memory 130 is also of a size suitable to store program instructions for displaying medicament data as well as other data to be displayed to the user.

Power source 145 is connected to and drives processor 125. Power source 145, in one embodiment, is a high energy density cell or plurality of cells. For example, power source 145 may be a battery (e.g. AA or AAA battery), a button cell battery, a coin cell battery, a rechargeable battery or any other power source suitable for use in a portable computing device.

Referring to FIG. 4, medicament container 100 includes indicator 140 located on a top side of case 105. Indicator 140 is connected to processor 125 and power source 145. Indicator 140 may be an audible alert (e.g., audible alarm), visual alert (e.g., light emitting diode (LED)), and/or vibration alert. Indicator 140 may be energized by processor 125 at a time required to take a particular medicament.

Referring to the embodiment illustrated in FIG. 4, processor 125 is also connected to display 150 and display 150 may be connected to power source 145. Display 150 is of a size suitable to convey readable information to a person (e.g., patient) holding or wearing case 105. In one embodiment, display 150 is a liquid crystal display (LCD) screen. Display 150 may also be, for example, a plasma screen or any other electronically controlled screen. Processor 125 sends signals to display 150 output as readable information.

In the embodiment illustrated in FIG. 4, processor 125 is also connected to audible output device 160, such as an audio speaker. Audible output device 160 may include a digital to analog converter and other circuitry capable of receiving signals from processor 125 and converting the signals into audible information such as verbal instructions. Audible output device 160 may be a device capable of making audible at least some portion of the information stored in memory 130 and executed by processor 125, such as some portion of the information shown on display 150. This audible information may be presented along with or instead of information shown on display 150. In one embodiment, audible output device 160 may also sound an alarm to alert the patient it is time to take one or more scheduled medicaments.

Referring to the embodiment illustrated in FIG. 4, medicament container 100 includes switch 155 on a top side of case 105. Switch 155 is also connected to processor 125. Switch 155 may be, for example, a button. Other suitable switches include, but are not limited to, dials, knobs or any mechanism that can be moved or actuated by a person to trigger processor 125. Representatively, switch 155 may trigger processor 125 to read memory 130 and send a signal to display 150 to output readable information or send a signal to audible output device 160 to generate audible information from medicament container 100. In another embodiment, medicament container 100 contains more than one switch 155 capable of changing the information displayed on display 150.

In the embodiment illustrated in FIG. 4, medicament container includes audio receiver 165 such as a microphone connected to processor 125. Audio receiver 165 may include an analog to digital converter and other circuitry capable of receiving verbal (audible) input and converting the input into signals that may be read by speech recognition software contained in processor 125. Instructions may be sent to processor 125 manually via switch 155 or audibly via audio receiver 165.

FIG. 4 representatively shows computing device 200, such as a personal computer. Computing device 200 may be any device capable of receiving, storing and transferring data. Computing device 200 is independent of medicament container 100 and, in one embodiment, may be electronically connected to medicament container 100 via interface 135 (e.g., cable 205 is connected at one end to computing device 200 and at another end to interface 135). Data is transferred from computing device 200 through interface 135 into memory 130. Although illustrated as cable 205, the data may be transferred remotely using a radio frequency or other wireless transmission.

Computing device 200 may receive, store and transfer medicament schedule and description data. With regard to description data, medicaments are not generally manufactured with the name of the medicament printed on it. Instead, this information is typically printed on the label of the packaging (e.g. pill bottle) with which the medicament is distributed to a person (e.g., a patient). Therefore, it is difficult to know exactly what a particular medicament is by inspection of the medicament itself. However, medicaments include a variety of characteristics that make them readily identifiable provided a patient has the knowledge to distinguish particular medicaments based on these characteristics.

Medicament characteristics include, but are not limited to, size; shape; color; colors; flavor; scent; texture; visual marks, for example, letters, numbers, cross-top, lines, indentations, palpable marks, corrugations, etc.; type of medicament, for example, a description whether the medicament is a tablet, capsule, gel capsule, pill, liquid, powder, spray, lotion, cream, ointment, etc; or other description capable of being detected by at least one of the five senses. Knowing one or more of these characteristics allows a patient to distinguish medicaments from one another.

Referring to FIG. 4, in one embodiment, computing device 200 may be programmed by a healthcare professional to include schedule data and appropriate medicament description data, including one or more medicament characteristics. The data may be inputted directly into computing device 200 by the health care professional or inputted in response to questions asked by a program stored in computing device 200. Representatively, computing device 200 has a capability to read, compile or store a resource such as The Physicians Desk Reference®. This allows a healthcare professional to access medicament information from the resource and apply it to the programming of computing device 200.

In one embodiment, after the medicament and schedule data is input into computing device 200, the health care professional transfers the data to memory 130 of medicament container 100 via interface 135. Interface 135 includes an external receiving end sufficient to receive data from magnetic or optical disks, cards, wires, wireless signals, etc. external to case 105. This information may also be saved on a hard drive of computing device 200 or to an external storage device, such as a floppy disk or compact disc that may be placed into a patient's file and/or given to a person responsible for medicament container 100 for their records or reference.

Referring to the embodiment of medicament container 100 illustrated in FIG. 4, processor 125 is programmed to execute machine-readable instructions using the data transferred from computing device 200. In one embodiment, the machine-readable instructions are stored in a read only memory (e.g., an electronically programmable read only memory) in medicament container 100. Alternatively, the machine-readable instructions may be carried out by specific hardware components, or by any combination of programmed and hardware components. For example, the instructions may be part of an application specific integrated circuit (ASIC) or some combination of programmed components and an ASIC.

The machine-readable instructions in processor 125 include instructions to convey schedule data and medicament description data (e.g., dose and description of one or more characteristics of the medicament(s) a person is scheduled to take or administer at a particular time). An internal clock, in one embodiment, is included as part of processor 125 to be checked against to indicate, for example, when a medicament is scheduled to be taken. In one embodiment, processor 125 executes the instructions conveying the name, dose, and description of one or more characteristics of the medicament(s) against the clock and the executed results are shown on display 150. Processor 125 may also signal audible output device 160 to sound an audible alert and/or generate verbal instructions.

The following paragraphs describe methods of using medicament container 100. It is appreciated that the methods are presented as examples of such use rather than limits on the possible uses of medicament container 100.

In one embodiment, medicament information is transmitted from computing device 200 to medicament container 100 via interface 135 and is stored in memory 130. A person (e.g., a patient) or healthcare professional loads (stores) one or more medicaments in compartment 110. Utilizing an internal clock, at an appropriate time to take or administer a medicament (administration alert time), processor 125 triggers indicator 140 to alert the person having control of medicament container 100. Processor 125 may alternatively or additionally signal speaker 160 to audibly alert the person.

At this administration alert time, processor 125 also executes instructions from memory 130 regarding a particular medicament stored in compartment 110. Such instructions are displayed on display 150 and include, for example, the time a medicament is to be taken, the medicament name, dosage, one or more particular characteristics about the medicament, and any cautionary or other information regarding the medicament. In another embodiment, processor 125 may alternatively or additionally signal speaker 160 to audibly instruct the person as to some or all of the above information.

In one embodiment, at the administration alert time, the above information is automatically shown on display 150 or communicated through audible output device 160 without a prompt from the person using medicament container 100. In another embodiment, after an alert by indicator 140 and/or audible output device 160, moving or actuating switch 155 is necessary to access the above instructions from display 150 and/or audible output device 160. Additional moving or actuation of switch 155 may be necessary to obtain additional medicament information, such as “take pill with two glasses of water” or “pill may cause drowsiness, do not drive”.

Following the administration alert, a person (e.g., a patient) opens door 112 of case 105 and accesses one or more medicaments within compartment 110 based on the information shown on display 150 or communicated through audible output device 160. In the embodiment where compartment 110 is one undivided or indivisible compartment, the information (e.g., one or more medicament characteristics) allows a person to differentiate between different types of medicaments that may be in compartment 110.

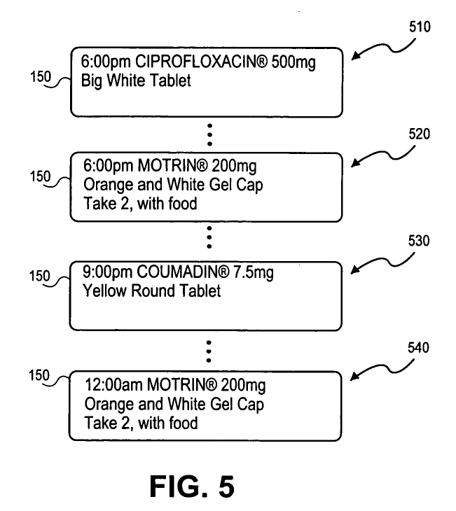

FIG. 5 shows a series of screen iterations of display 150 representing, for example, a schedule of medicaments to be taken for a portion of one day. These iterations may be automatically displayed at the appropriate administration alert time or prompted by moving or actuating switch 155. In one embodiment, iteration 510 shows the scheduled administration alert time, name, dosage, and one or more characteristics of a scheduled medicament. In another embodiment, multiple iterations may be necessary to show the complete information. For a particular administration alert time, multiple iterations may be necessary to display multiple medicaments (e.g., iteration 510 and iteration 520). These multiple iterations may need to be prompted by switch 155.

FIG. 5 also shows iteration 530 and iteration 540 representing medicament information for administration times subsequent to iteration 510 and iteration 520. Iteration 540 is an administration time following an administration time represented by iteration 530.

In between administration alert times, a person may be able to access the next or previously taken medicament information by, for example, moving or actuating switch 155. In another embodiment, a plurality of switches 155 may be utilized to access medicament and/or schedule information.

In another embodiment, processor 125 may be accessed by voice commands through audio receiver 165 to perform all functions previously described for switch 155. Audio receiver 165 may be used additionally or alternatively to switch 155.

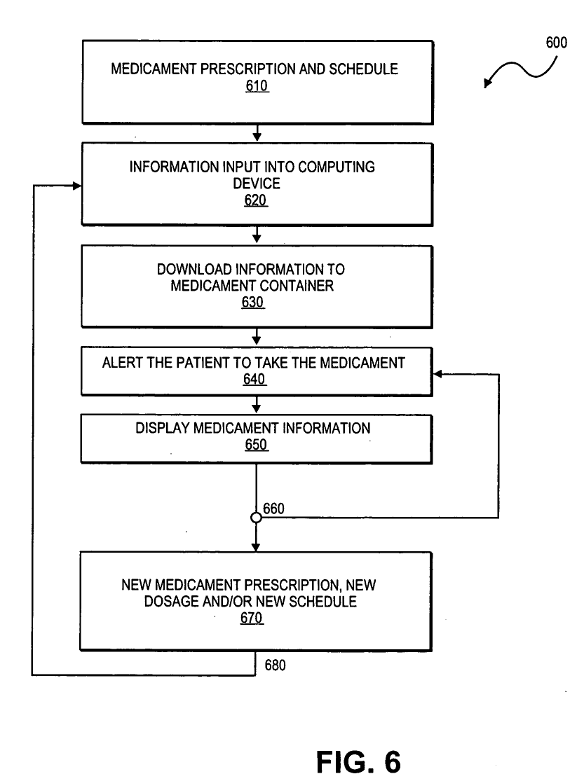

FIG. 6 shows a block diagram of a method of reminding a person to take or administer a medicament. In this embodiment, method 600 begins with a healthcare professional prescribing medicament(s) and the schedule of when the person is to take or administer the medicament(s) (block 610). The healthcare professional, in one embodiment, may then input the schedule, medicament names, dosages and medicament characteristic(s) into an independent computing device (block 620).

In one embodiment, the times, medicament names, doses, characteristics and other information are programmed or downloaded from the independent computing device via a cable link or wireless link into a memory executable by a processor contained within the medicament container (block 630).

When a person is scheduled to take or administer a medicament, the person is alerted (block 640). In one embodiment, when the alert is given, the time, medicament name, dose, at least one characteristic of the scheduled medicament(s) and other information is described to the patient (block 650). The person is subsequently alerted, in one embodiment, of additional medicaments to take or administer at future scheduled times with the appropriate medicament descriptions (660).

The above method may continue for some time such as for a length of a prescription period of one or more medicaments. After such time, a health care professional may evaluate, for example, a particular treatment regimen and update the regimen. For example, a health care professional may prescribe a new medicament, a new medicament dosage, and/or a new schedule (block 670). At that point, the health care professional would input the new information into an independent computing device and ultimately to the medicament container (680).

In the preceding paragraphs, specific embodiments are described. It will, however, be evident that various modifications and changes may be made thereto without departing from the broader spirit and scope of the claims. The specification and drawings are, accordingly, to be regarded in an illustrative rather than a restrictive sense.

What is claimed is:

1. An apparatus comprising:
an enclosed compartment suitable for containing a plurality of medicaments and of a size suitable for being carried by an individual; and
a processor,
wherein a first data output from the processor informs when to take a medicament, and
wherein a second data output from the processor describes at least one characteristic of the medicament.

2. The apparatus of claim 1 further comprising:
a display coupled to the processor for viewing data output from the processor.

3. The apparatus of claim 1, wherein the characteristic of the medicament is one of size, shape, color, scent, flavor, texture and visual marks.

4. The apparatus of claim 1, further comprising:
a memory coupled to the processor of a size suitable to store instructions to allow the processor to inform when to take at least one medicament and to describe at least one characteristic of the medicament.

5. The apparatus of claim 1, further comprising:
a switch coupled to the processor and accessible by an individual,
wherein activating the switch signals the processor to output information regarding at least one additional characteristic of the medicament on the display.

6. The apparatus of claim 1, further comprising:
a switch coupled to the processor and accessible by an individual,
wherein actuating the switch a first time signals the processor to output information regarding a medicament to be taken at a first interval and actuating the switch a second time signals the processor to output information regarding a medicament to be taken at a second, subsequent interval.

7. The apparatus of claim 1, wherein the processor comprises an output comprising a schedule of medicament information for a pre-determined period.

8. The apparatus of claim 1, wherein the processor comprises an output comprising a schedule and medicament information regarding medicaments to be administered within a pre-determined prior period.

9. The apparatus of claim 1, wherein the display is capable of displaying dosage, time, medicament information, dosage information and a visual alert at one time.

10. The apparatus of claim 1, further comprising:
an indicator,
wherein the indicator is at least one of a visual warning on the display, an audio alert, a visual alert, and a vibration alert.

11. The apparatus of claim 1, wherein the apparatus has a size suitable such that it can be worn on a belt of an individual.

12. The apparatus of claim 1, wherein the compartment is indivisible.

13. The apparatus of claim 1, further comprising a data link interface coupled to the processor for sending and receiving data to or from a computing device independent of the case.

14. A method, comprising:
programming a description of at least one characteristic of a medicament and a schedule of when to take the medicament into a memory executable by a processor coupled to a case to be carried by a person, the case including a container suitable for containing a plurality of medicaments.

15. The method of claim 14, wherein the characteristic of the medicament is one of size, shape, color, colors, scent, flavor, texture and visual marks.

16. The method of claim 14, wherein the schedule is a first schedule, the method further comprising:
replacing the first schedule of when to take the first medicament with a second schedule of when to take the first medicament; and
re-programming the memory to include the second schedule.

17. The method of claim 14, wherein the medicament is a first medicament, the method further comprising:
replacing the first medicament with a second medicament; and
re-programming the memory to include a description of at least one characteristic of the second medicament.

18. The method of claim 14, wherein the schedule is a first schedule and the medicament is a first medicament, the method further comprising:
programming a description of at least one characteristic of a second medicament and a second schedule of when to take the second medicament into the memory.

19. A machine readable medium containing program instructions that when executed cause a processor to perform a method comprising:
alerting a person of a time to take at least one medicament; and
informing of at least one characteristic of the at least one medicament.

20. The machine readable medium of claim 19, wherein the at least one characteristic is one of size, shape, color, texture, and visual marks.
